(19) United States
(12) Patent Application Publication
(10) Pub. No.: US 2010/0098810 A1
(43) Pub. Date: Apr. 22, 2010

(54) INSTANT SUGAR-COATED POWDERED BEVERAGE

(75) Inventor: TAI-YU LIN, Taipei Hsien (TW)

Correspondence Address: WPAT, PC;INTELLECTUAL PROPERTY ATTORNEYS, 7225 BEVERLY ST., ANNANDALE, VA, 22003, US

(73) Assignee: TAI-YU LIN, Taipei Hsien (TW)

(21) Appl. No.: 12/253,532

(22) Filed: Oct. 17, 2008

(51) Int. Cl. A23P 1/04

(52) U.S. Cl. 426/96

(57) ABSTRACT

An instant sugar-coated powdered beverage includes a water-soluble dehydrated beverage substance and an enclosure. The enclosure is a hollow case made of sugar for sealing the dehydrated beverage substance therein. The enclosure includes an upper half cover and a lower half cover, which are bonded together by coating a layer of syrup over a joint therebetween. When the syrup is set, a complete enclosure is formed. The dehydrated beverage substance is positioned in the lower half cover before the upper half cover is bonded to the lower half cover. After the complete enclosure is formed, the dehydrated beverage substance is sealed in the enclosure.

### FIELD OF THE INVENTION

The present invention relates to an instant sugar-coated powdered beverage, and more particularly to an instant three-in-one powdered beverage packaged in a novel way to create a completely new impression on users.

### BACKGROUND OF THE INVENTION

People drink water to maintain their bodies in a water-balanced condition. In the modern society, due to great stress and tense in work and daily life, some people also drink beverages to obtain necessary water while relaxing their bodies to enjoy an easy and pleasant feeling.

People in the modern society emphasize efficiency and tend to drink beverages in a convenient way, too. Therefore, various kinds of convenient instant beverages, such instant coffee, instant cocoa, blended milk and tea, tea bags, have been developed and introduced into the market. The so-called three-in-one instant beverage is an example of the convenient beverages produced in response to the demands of consumers in the modern society.

Currently, various kinds of three-in-one instant beverages are generally packaged in plastic bags. To drink the three-in-one instant beverage, a user needs only to tear open the plastic bag and pour the powdered beverage substance into water. When the powdered beverage substance has fully dissolved in the water, the beverage is ready for drinking. In a commercially available three-in-one instant coffee, for example, there are contained dehydrated coffee, sugar, and creamy powder. After brewed, the beverage will release aroma from coffee, sugar, and the creamy powder. It is known some powdered ingredients of the three-in-one instant beverage will attach to and remain on an inner face of the plastic bag when the plastic bag has been torn open to pour out the powdered beverage substance. Therefore, some part of the gradients of the instant beverage are wasted. On the other hand, the sugar content in the commercially available three-in-one instant beverages is fixed and does not allow a user to reduce the sweetness of the beverage. As a result, some people who dislike sweet beverages may decide not to drink the three-in-one instant beverages.

### SUMMARY OF THE INVENTION

A primary object of the present invention is to provide an instant sugar-coated powdered beverage, which provides a new way of packaging a three-in-one instant beverage to attract consumers and enable increased competing ability of the instant beverage in the market.

Another object of the present invention is to provide an instant sugar-coated powdered beverage; all the ingredients thereof can be completely dissolved in water without being wasted.

A further object of the present invention is to provide an instant sugar-coated powdered beverage that allows a user to reduce the sugar content thereof according to personal preference.

To achieve the above and other objects, the instant sugar-coated powdered beverage according to the present invention includes a dehydrated beverage substance and an enclosure. The dehydrated beverage substance is water-soluble, and the enclosure is a hollow case made of sugar adapted to seal the dehydrated beverage substance therein.

The enclosure includes an upper half cover and a lower half cover, which are bonded together by coating a layer of syrup over a joint therebetween. When the syrup is set, a complete enclosure is formed. The dehydrated beverage substance is positioned in the lower half cover before the upper half cover is bonded to the lower half cover. After the complete enclosure is formed, the dehydrated beverage substance is sealed in the enclosure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an assembled perspective view of an instant sugar-coated powdered beverage according to a first embodiment of the present invention;

FIG. 2 is an exploded view of FIG. 1;

FIG. 3 is a vertical sectional view of FIG. 1;

FIG. 4 is a perspective view showing the use of the instant sugar-coated powdered beverage according to the present invention;

FIG. 5 is an assembled perspective view of an instant sugar-coated powdered beverage according to a second embodiment of the present invention;

FIG. 6 is an exploded view of FIG. 5;

FIG. 7 is an exploded perspective view of an instant sugar-coated powdered beverage according to a third embodiment of the present invention; and

FIG. 8 is an assembled perspective view of an instant sugar-coated powdered beverage according to a fourth embodiment of the present invention.

### DETAILED DESCRIPTION OF THE PREFERRED EMBODIMENTS

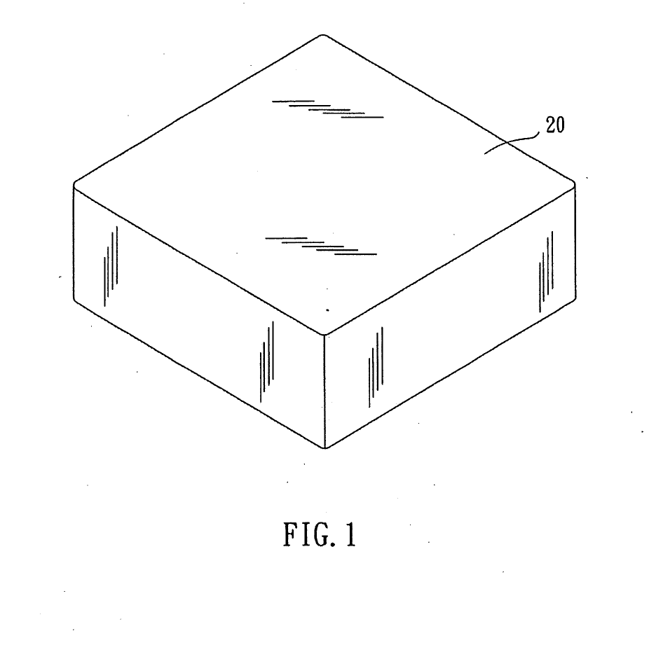

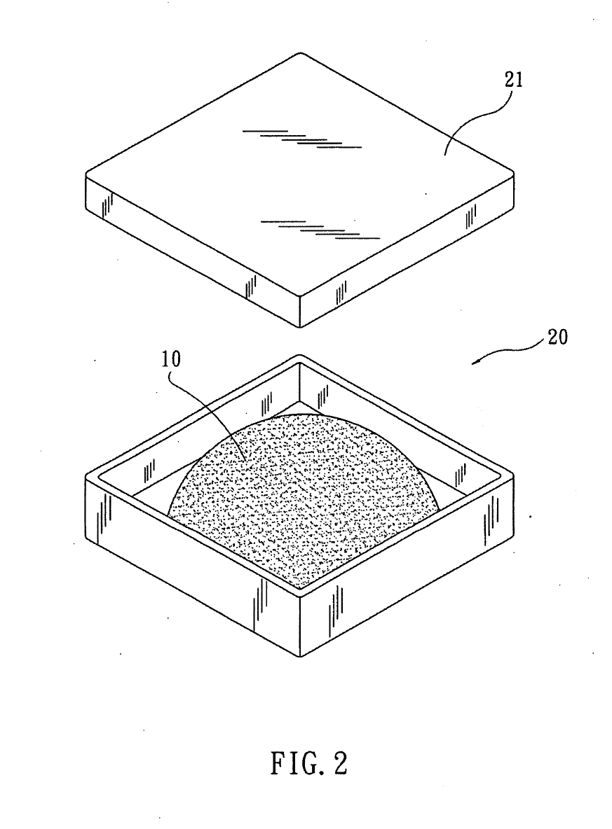

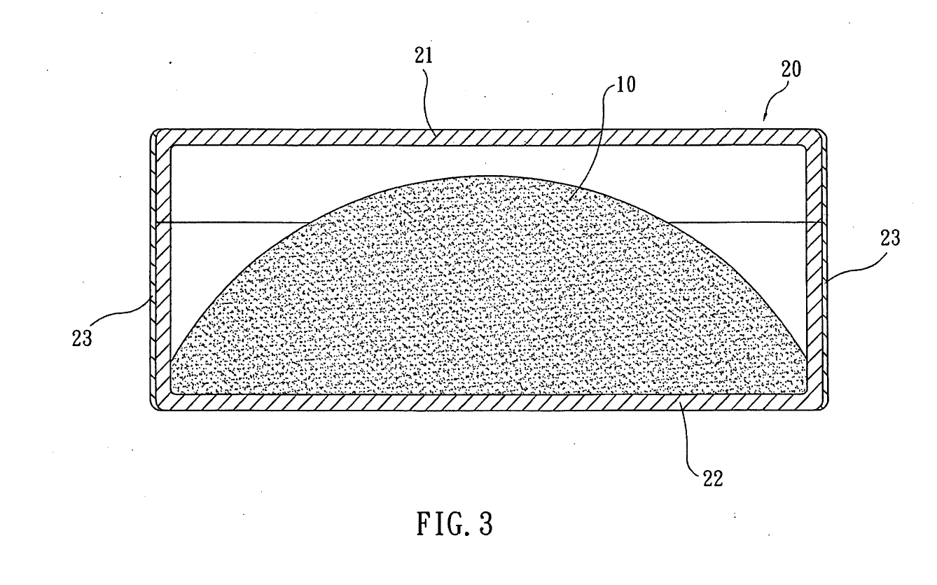

Please refer to FIGS. 1 and 2 that are assembled and exploded perspective views, respectively, of an instant sugar-coated powdered beverage according to a first embodiment of the present invention, and to FIG. 3 that is a vertical sectional view of FIG. 1. The present invention provides a three-in-one instant beverage that is packaged using the material thereof. In the first embodiment, the instant sugar-coated powdered beverage of the present invention includes a dehydrated beverage substance 10 and an enclosure 20 for enclosing the dehydrated beverage substance 10 therein. The dehydrated beverage substance 10 is water-soluble. The enclosure 20 is a hollow case made of sugar adapted to seal the dehydrated beverage substance 10 therein.

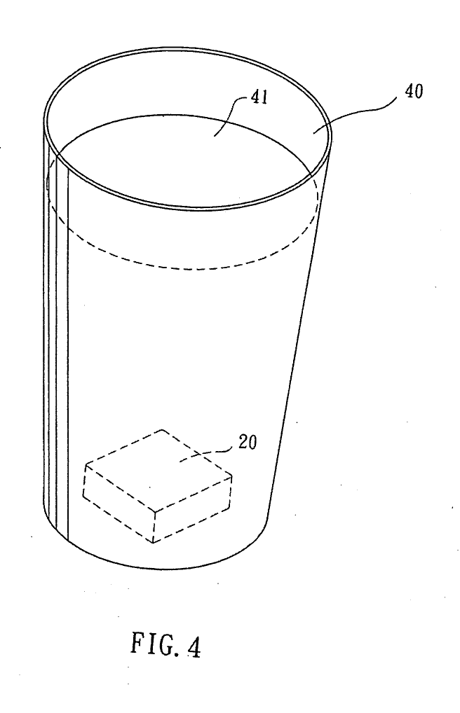

The sugar forming the enclosure 20 constitutes one of the three ingredients of the three-in-one instant beverage. The dehydrated beverage substance 10 does not contain sugar, and the sugar prepared for the instant beverage is used to form the enclosure 20. Referring to FIG. 4, when the instant sugar-coated powdered beverage is positioned in a container 40 with water 41, the sugar-made enclosure 20 will gradually dissolve in the water 41 to form a hole, via which the dehydrated beverage substance 10 runs out of the enclosure 20 and the water 41 enters the enclosure 20, bringing the dehydrated beverage substance 10 to fully dissolve in the water 41 for drinking.

In the first embodiment shown in FIGS. 1 to 3, the enclosure 20 is cuboidal in shape. To make the enclosure 20, as shown in FIG. 2, first form an upper half cover 21 and a lower half cover 22, which can be joined together to complete the enclosure 20 later. A joint between the upper and lower half cover 21, 22 is further coated with a layer of syrup 23. After the syrup 23 is set, the upper and lower half covers 21, 22 are bonded together to form the complete enclosure 20. The dehydrated beverage substance 10 is positioned in the lower half cover 22 before the upper half cover 21 is bonded to an open top of the lower half cover 22. When the complete enclosure 20 is formed, the dehydrated beverage substance 10 is sealed in the enclosure 20.

The dehydrated beverage substance 10 is in a dried state, and can be in the form of powder or granules. And, the dehydrated beverage substance 10 can be, for example, powdered coffee, tea-made products, and powered milk.

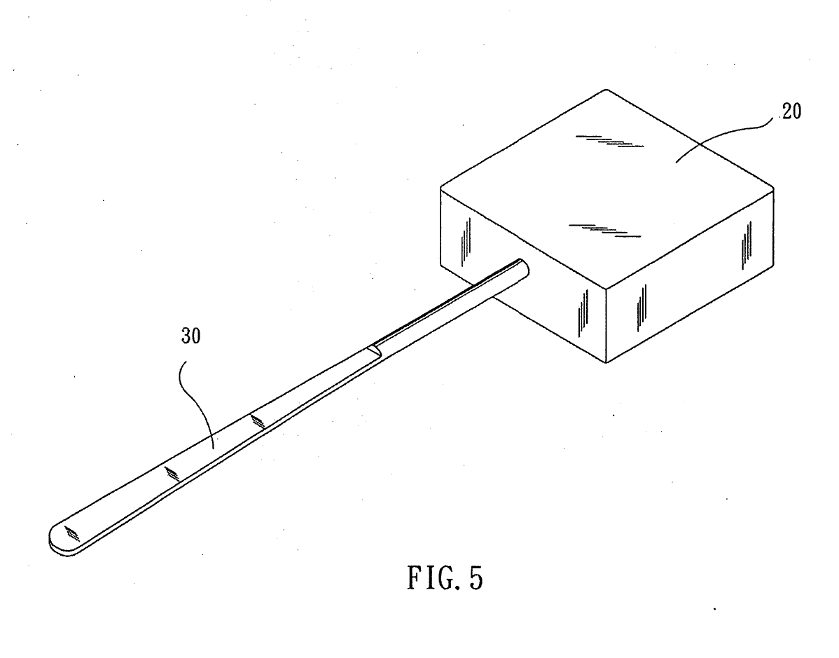

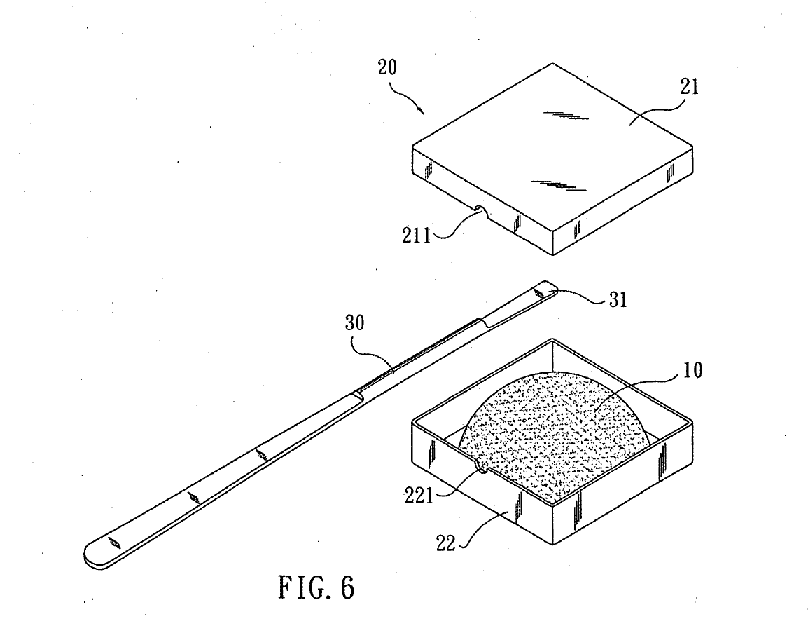

FIG. 5 shows an instant sugar-coated powdered beverage according to a second embodiment of the present invention. The second embodiment is structurally similar to the first embodiment, except for a muddler 30. The muddler 30 has inner end extended into the enclosure 20 and is fixedly connected to the enclosure 20. A user can hold the muddler 30 and extend the enclosure 20 into water in a container, and vibrates the muddler 30 for the enclosure 20 to dissolve in the water more quickly. FIG. 6 is an exploded view of FIG. 5. As can be seen from FIG. 6, the muddler 30 has a flat inner end 31 to provide better blending effect. By vibrating the muddler 30 in the water, the dehydrated beverage instance 10 and the sugar-made enclosure 20 can be more quickly dissolved in the water. The muddler 30 is fixedly connected to the enclosure 20 when the upper and lower half covers 21, 22 are bonded together using the syrup 23. The upper and lower half covers 21, 22 are correspondingly provided with a notch 211, 221 each. The two notches 211, 221 together define a through hole, via which the muddler 30 is extended into the enclosure 20. Since the enclosure 20 and the dehydrated beverage substance 10 sealed in the enclosure 20 would not attach or stick to an external package therefor, the dehydrated beverage substance 10 and the enclosure 20 of the instant sugar-coated powdered beverage can be completely dissolved in the water without being wasted.

In practice, the enclosure 20 is packaged with a plastic bag to keep the instant sugar-coated powdered beverage in a non-contaminated condition. In the case a user desires to drink the beverage with less sugar, the user can first break the enclosure 20 to remove part of the enclosure 20, so that the beverage brewed from the dissolved enclosure 20 and dehydrated powdered beverage substance 10 is not so sweet for drinking.

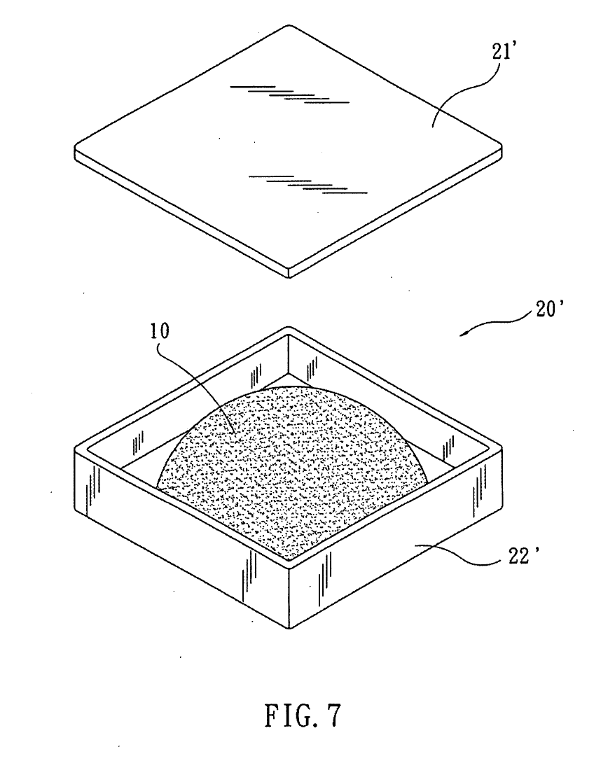

FIG. 7 is an exploded perspective view showing a third embodiment of the present invention having an enclosure 20′ consisting of an upper half cover 21′ and a lower half cover 22′. The upper half cover 21′ is in the form of a flat plate for fitly closing an open top of the lower half cover 22′.

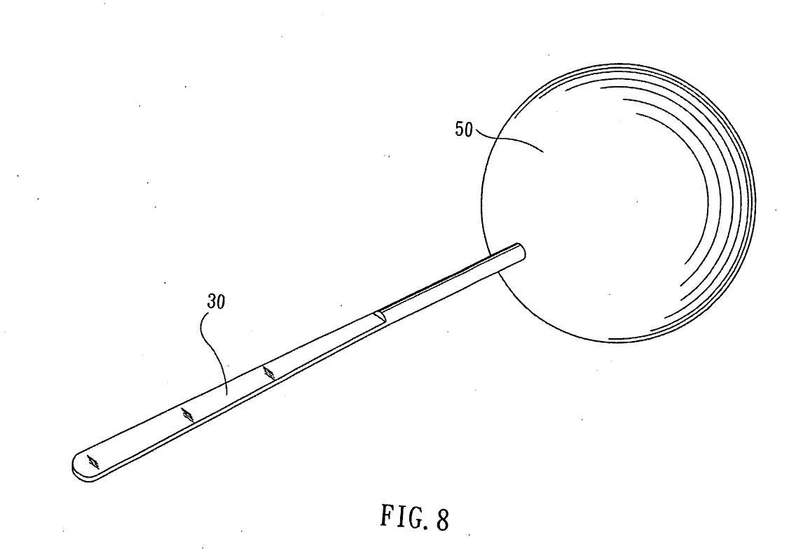

FIG. 8 is an assembled perspective view showing a fourth embodiment of the present invention having an enclosure 50 in the form of a spherical body. It is understood, the enclosure can be any other different shapes, such as a heart-shaped or an animal-shaped enclosure. For example, when the dehydrated beverage substance 10 is a three-in-one instant coffee, the enclosure can be configured as a coffee bean.

In conclusion, with the sugar-made enclosure, the instant beverage provided by the present invention shows a new and novel packaging manner to attract consumers without increasing material and packaging costs of the three-in-one instant beverage.

What is claimed is:

1. An instant sugar-coated powdered beverage comprising:
a dehydrated beverage substance, which is water-soluble; and
an enclosure being a hollow case made of sugar, and the dehydrated beverage substance being sealed in the enclosure.

2. The instant sugar-coated powdered beverage as claimed in claim 1, wherein the dehydrated beverage substance can be in the form of powder or granules.

3. The instant sugar-coated powdered beverage as claimed in claim 1, wherein the enclosure is formed from an upper half cover and a lower half cover, and the upper and the lower half covers being bonded together by coating a layer of syrup over a joint therebetween.

4. The instant sugar-coated powdered beverage as claimed in claim 3, wherein the upper half cover of the enclosure is in the form of a flat plate to fitly close an open top of the lower half cover.

5. The instant sugar-coated powdered beverage as claimed in claim 1, further comprising a muddler, an inner end of the muddler being extended into the enclosure and fixedly connected to the enclosure.

6. The instant sugar-coated powdered beverage as claimed in claim 5, wherein the inner end of the muddler is in the form of a flat plate.
